(19) United States
(12) Patent Application Publication
(10) Pub. No.: US 2011/0218705 A1
(43) Pub. Date: Sep. 8, 2011

(54) TROUBLE NOTIFICATION APPARATUS AND IN-VEHICLE APPARATUS

(75) Inventor: Masaya ITO, Kariya-city (JP)

(73) Assignee: DENSO CORPORATION, Kariya-city (JP)

(21) Appl. No.: 13/033,859

(22) Filed: Feb. 24, 2011

(30) Foreign Application Priority Data
Mar. 3, 2010 (JP) 2010-46793

(51) Int. Cl. G06F 19/00

(52) U.S. Cl. 701/35; 701/29

(57) ABSTRACT

An in-vehicle apparatus, used in a vehicle having a speed limit release mode, is configured to stop sending trouble occurrence information to an information collection center when the speed limit release mode is being turned on. Stopping of the information sending allows a hard disk drive in the in-vehicle apparatus not to have an access thereto, thereby decreasing possibility of hard disk related problems in the vehicle.

### CROSS REFERENCE TO RELATED APPLICATION

The present application is based on and claims the benefit of priority of Japanese Patent Application No. 2010-46973, filed on Mar. 3, 2010, the disclosure of which is incorporated herein by reference.

### FIELD OF THE INVENTION

The present disclosure generally relates to a trouble notification apparatus and an in-vehicle apparatus.

### BACKGROUND INFORMATION

When a predetermined condition is satisfied, a technology for controlling a drive control ECU for allowing a travel of a vehicle at the speed exceeding the upper limit of the allowable range of the vehicle speed is known in a conventional art (refer to a patent document 1 in the following, for example). A mode allowing a travel at the speed exceeding the upper limit of the allowable range of the vehicle speed is denoted as a speed limit release mode.

[Patent document 1] Japanese Patent Laid-Open No. 2009-61800

According to the assumption of the inventor, the vehicle may be used in a severe environment when the speed limit release mode is used. Therefore, various devices in the vehicle may output trouble occurrence information frequently, and, as a result, an overflow of trouble occurrence information is expected.

In case that all of the trouble occurrence information is configured to be transmitted to an outside of the vehicle to an information collection center, for example, the information collection center may receive a huge amount of the trouble occurrence information. However, the trouble occurrence information in the speed limit release mode is highly possibly related to a trouble that is temporarily caused due to the travel of the vehicle in the speed limit release mode, and the trouble is highly possibly resolved when the speed limit release mode of the vehicle is released or is turned off. In other words, unnecessary “noise” information will be transmitted to the information collection center by a large amount if all of the trouble occurrence information is configured to be transmitted to the center in the speed limit release mode.

### SUMMARY OF THE INVENTION

In view of the above and other problems, the present invention is provided primarily for reducing the unnecessary noise information in the speed limit release mode, which may otherwise be transmitted to the information collection center.

In addition, it is very likely that a hard disk carried by a vehicle breaks down because the use environment of the vehicle becomes severe in the speed limit release mode. Therefore, reducing possibility of the trouble of the hard disk carried by the vehicle in the speed limit release mode is simultaneously aimed at by the present invention.

In an aspect of the present invention, a trouble notification apparatus, for use in a vehicle for transmitting trouble occurrence information regarding a trouble of the vehicle to an information center outside of the vehicle, includes: an information transmitting unit for transmitting the trouble occurrence information to the information center; a speed limit release mode setting unit for setting ON and OFF of a speed limit release mode, wherein the speed limit release mode is turned ON when a first condition is fulfilled and the speed limit release mode is turned OFF when a second condition is fulfilled; and an upper speed limit control unit for controlling a travel speed of the vehicle, wherein, based on a control of a drive control ECU in the vehicle, the travel speed of the vehicle is set to be within a speed range having a first upper limit speed during an OFF period of the speed limit release mode, and, the travel speed of the vehicle is allowed to exceed the first upper limit speed during an ON period of the speed limit release mode.

In the above configuration, the transmission of the trouble occurrence information to the center is stopped when the speed limit release mode is turned ON, unnecessary noise information transmitted to the center is reduced.

In another aspect of the present invention, an in-vehicle apparatus for use in a vehicle includes: a hard disk; a speed limit release mode setting unit for turning on and off of a speed limit release mode, which is turned on when a first condition is fulfilled and is turned off when a second condition is fulfilled; an upper speed limit control unit for controlling a travel speed of the vehicle, the travel speed of the vehicle being set to be within a speed range having an upper limit speed in the vehicle during an ON period of the speed limit release mode, and, the travel speed of the vehicle being allowed to exceed the upper limit speed during an OFF period of the speed limit release mode, based on a control of a drive control ECU in the vehicle; and a hard disk control unit for controlling an operation of the hard disk, that is, the operation of the hard disk is stopped during an ON period of the speed limit release mode.

In the above configuration, the operation of the hard disk is stopped when the speed limit release mode is turned on, thereby possibility of the trouble of the hard disk is reduced.

In addition, the in-vehicle apparatus further includes a flash memory, and the speed limit release mode setting unit switches ON and OFF of the speed limit release mode by rewriting information stored in the flash memory, and the upper speed limit control unit and the hard disk control unit determine whether the speed limit release mode is being turned ON or OFF based on the information stored in the flash memory.

If, according to a different configuration from the above, the speed limit release mode is switched on and off by rewriting the information in the hard disk, the turning on and off of the speed limit release mode as well as determination of whether the speed limit release mode is turned on or off cannot be performed during the ON period of the speed limit release mode due to the denial of access to the hard disk in that period. The present invention avoids such a problem by storing the information in the flash memory instead of the hard disk. A similar problem of use of a random access memory (RAM) can also be avoided when the information is stored in the flash memory. That is, if the information is stored in the RAM for switching on and off of the speed limit release more, the information in the RAM may be unstable due to a frequent rewriting and/or erasure of the information during an engine start period. However, the non-volatile flash memory is not susceptible to the instability of electric supply during the engine start period, thereby resolving the above-described problem.

The numerals used in the above show correspondence between the above terms and an example shown in the embodiment of the present invention.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of a communication system in an embodiment of the present invention;

FIG. 2 is a block diagram of processes performed by a main microcomputer 12d;

FIG. 3 is a flowchart of a speed limit release mode setting process;

FIG. 4 is a sequence diagram of operation of a navigation system and a drive control ECU in a mode control process; and

FIG. 5 is another sequence diagram of operation of the navigation system and a drive control ECU in the mode control process.

### DETAILED DESCRIPTION

Embodiments of the invention are explained in the following.

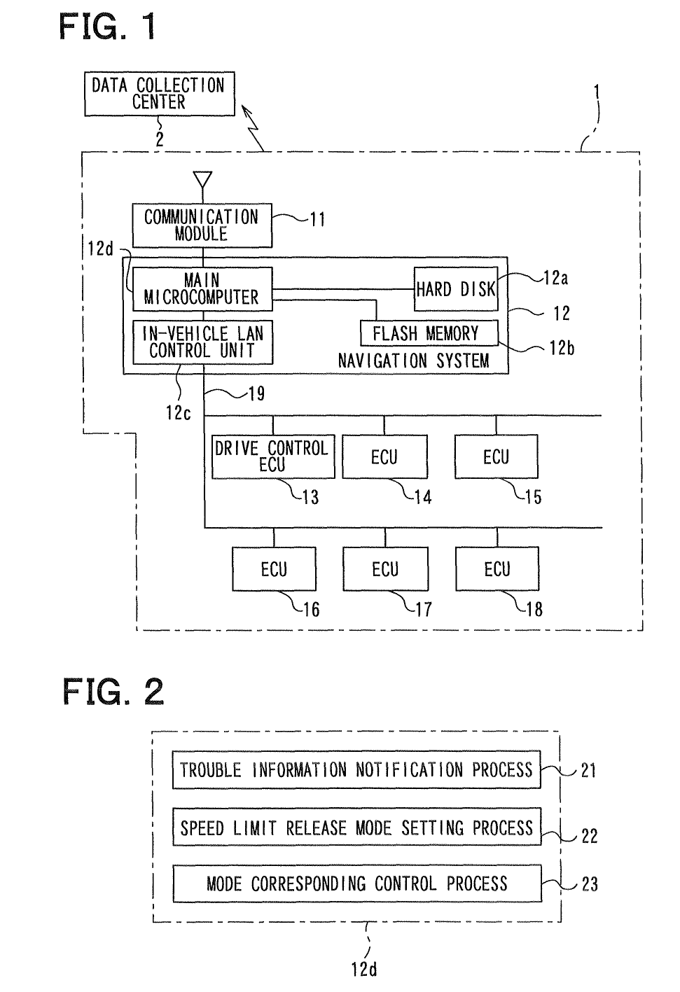

The configuration of a communication system of the present embodiment is schematically shown in FIG. 1.

The communication system includes an in-vehicle system 1 installed in a vehicle and a data collection center 2 in an outside distant place away from the vehicle concerned. The in-vehicle system 1 collects trouble occurrence information about the trouble that occurred in the vehicle, and transmits collected trouble occurrence information to the data collection center 2. The data collection center 2 has CPU, RAM, ROM, a hard disk, a communication equipment (not illustrated), and the CPU receives the trouble occurrence information mentioned above through the communication equipment, and received trouble occurrence information is compiled into a database and is recorded on the hard disk.

The recorded trouble occurrence information is passed on to a vehicle dealer, or a design section of a vehicle maker. The dealer makes a prior arrangement of replacement parts, for example, based on the passed-on information, and the design section of the vehicle maker performs a trend analysis of the trouble based on the passed-on information, for example.

The trouble occurrence information may be transmitted from the in-vehicle system 1 to the data collection center 2 through wireless connection (e.g., wireless connection by the wireless LAN) between the in-vehicle system 1 and a radio base station in combination with a wide area network connecting the radio base station and the data collection center 2 (e.g., Internet), or may be transmitted through a direct wireless communication (e.g., communication by Bluetooth).

The in-vehicle system 1 includes a communication module 11, a navigation system 12, a drive control ECU 13, other ECUs 14 to 18. The navigation system 12 and ECUs 13 to 18 can communicate with each other through an in-vehicle LAN 19.

The communication module 11 is a radio device for transmitting the trouble occurrence information to the data collection center 2. The communication module 11 wirelessly transmits the trouble occurrence information output from the navigation system 12, after performing various well-known processes such as modulation, amplification, frequency conversion and the like, under control of the navigation system 12.

The drive control ECU 13 calculates target drive indexes of vehicle's driving force generator (e.g., a gasoline engine of a vehicle, an electric motor of an electric vehicle) such as a target engine rotation, a target motor rotation, based on a detection signal output from sensors such as a accelerator opening sensor (not illustrated) and the like, and controls the driving force generator for achieving the target indexes.

The drive control ECU 13 has information of a vehicle speed limit value VL stored in, for example, RAM or a flash memory of the drive control ECU 13. The vehicle speed limit value VL is an upper limit value of an allowable range of a travel speed of the vehicle. The vehicle speed limit value VL is the first upper limit speed that is lower than a maximum speed of the vehicle that is defined by the vehicle's performance.

The drive control ECU 13 detects a vehicle speed based on output signals from a speed sensor (not illustrated) in the vehicle during a normal travel time of the vehicle, that is, until receiving a speed limiter release request from the navigation system 12 through the in-vehicle LAN 19, and performs a control that reduces the target drive indexes of the driving force generator for the vehicle to travel at a speed that is lower than the speed limit value VL when the detected vehicle speed exceeds the speed limit value VL. Such a control is called as a speed limiter control.

However, after receiving the speed limiter release request from the navigation system 12 through the in-vehicle LAN 19 until receiving a speed limiter setting request from the navigation system 12 through the in-vehicle LAN 19, the drive control ECU 13 does not perform the speed limiter control. In other words, the ECU 13 allows the vehicle to travel at a speed that exceeds the first upper limit speed. In this manner, the vehicle's speed can be raised to the maximum performance speed.

In addition, the drive control ECU 13 performs the speed limiter control after receiving the speed limiter setting request, until receiving the speed limiter release request.

In addition, the drive control ECU 13 is configured to repeatedly transmit a speed limiter setting response signal to the navigation system 12 at regular intervals of several milliseconds while performing the speed limiter control, for example, and to repeatedly transmit a speed limiter release response signal to the navigation system 12 at regular intervals of several milliseconds while not performing the speed limiter control.

An example of other ECUs 14 to 18 includes a brake control ECU that controls application of braking force to the vehicle according to a detection signal from a brake stroke sensor (not illustrated), for example. These ECUs 13 to 18 detect trouble occurrence of vehicle devices, and transmits, as the trouble occurrence information, the trouble type as well as the detailed contents of the detected trouble to the navigation system 12 through the in-vehicle LAN 19.

For example, the drive control ECU 13 detects the abnormality of engine rotation based on a detection signal output from an engine rotation sensor (not illustrated), and transmits, as the trouble occurrence information, trouble type information specifying “engine trouble” and detailed trouble information indicative of a value of the engine rotation to the navigation system 12 when the detected trouble is determined as abnormal.

Further, the drive control ECU 13 detects abnormality of engine oil based on a detection signal output from an oil temperature sensor (not illustrated), and transmits, as the trouble occurrence information, trouble type information specifying “engine trouble” and detailed trouble information indicative of a value of the engine oil temperature to the navigation system 12 when the detected trouble is determined as abnormal.

For realizing the above-described functions, each of the ECUs 13 to 18 has a microcomputer which has CPU, RAM, ROM, and those functions are realized by the CPU executing a program stored in the ROM.

The navigation system 12 includes a hard disk 12a, a flash memory 12b, an in-vehicle LAN control unit 12c, a main microcomputer 12d and the like.

The hard disk 12a has a disk which has a magnetic body applied thereon and a magnetic head, and turns the disk at a high speed for storing and retrieving information to and from the disk. In the hard disk 12a, various kinds of data are stored, such as map data for map display and map guidance, as well as other kinds of data.

The flash memory 12b is a nonvolatile semiconductor memory. In the flash memory 12b, a limiter release flag to mention later is recorded.

The in-vehicle LAN control unit 12c is a well-known communication interface used by the main microcomputer 12d for communication with other ECUs 13 to 18 through the in-vehicle LAN 19.

The main microcomputer 12d is a well-known microcomputer having CPU, RAM, and ROM. Various processes in the main microcomputer 12d to be mentioned later are realized by the CPU carrying out various programs recorded in the ROM.

A typical process performed by the main microcomputer 12d includes a position determination process, a map display process, a route finding process, a route guidance process and the like.

The position determination process is a process to identify a current position of the vehicle based on the signal from a position sensor in the vehicle (e.g., a vehicle speed sensor, a GPS receiver and the like, not illustrated).

The map display process is a process that generates a map image of an area including the current position of the vehicle based on the map data on the hard disk 12a, and displays the generate map image on an image display device (not illustrated) on the vehicle.

The route finding process is a process that specifies a destination based on a destination input operation by the user from an operation unit (not illustrated) of the navigation system 12, and calculates an optimum route from the current position to the destination based on the map data.

The route guidance process is a process that provide a guidance according to the calculated guidance route such as an output of a right/left turn guidance, a display of an intersection expansion view and the like.

FIG. 2 shows a part of the process performed by the main microcomputer 12d by the execution of the program, except for the above-described ones. That is, the main microcomputer 12d executes a trouble information notification process 21, a speed limit release mode setting process 22, and a mode corresponding control process 23. The main microcomputer 12d executes, simultaneously in substance and in a time-sharing method, the above processes as well as the trouble information notification process 21, the speed limit release mode setting process 22, and the mode corresponding control process 23.

The trouble information notification process 21 is explained first. The trouble information notification process 21 accumulates the trouble occurrence information transmitted from ECUs 13 to 18 to the navigation system 12 in RAM, and transmits, by using the communication module 11 at a scheduled timing, the accumulated trouble occurrence information to the data collection center 2 collectively as a bundle of data. Whether or not to perform the trouble information notification process 21 is controlled by the mode corresponding control process 23 as mentioned later. In addition, the trouble information notification process 21 is configured to be always executed at a time of shipment of the in-vehicle system 1.

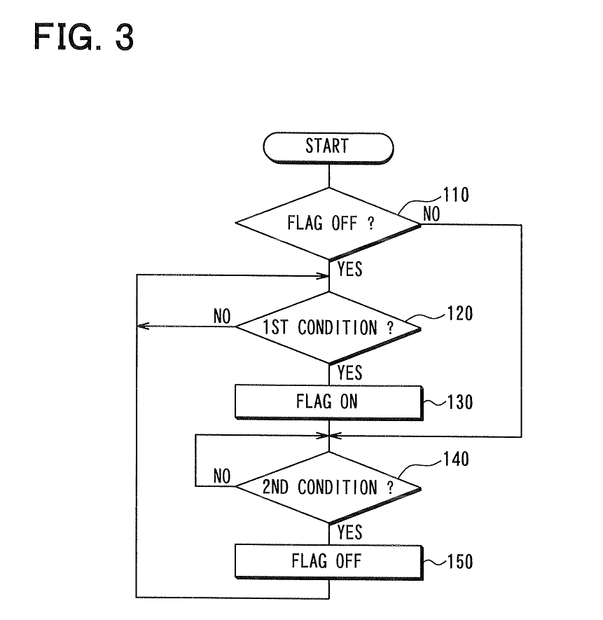

The speed limit release mode setting process 22 is explained next. The speed limit release mode setting process 22 is to switch on and off the speed limit release mode. FIG. 3 shows a flowchart of the speed limit release mode setting process 22. The main microcomputer 12d always executes the process during its operation time, and, at step 110 determines whether a value of a limiter release flag recorded in the flash memory 12b indicates an “OFF,” and, if the value is “OFF,” successively executes step 120, or, if the value is “ON,” successively executes step 140.

At step 120, the process waits for the fulfillment of the first condition, to proceed to step 130 after the fulfillment of the first condition and to change the limiter release flag in the flash memory 12b to “ON,” and then the process proceeds to step 140. At step 140, the process waits for the fulfillment of the second condition, to proceed to step 150 after the fulfillment of the second condition and to change the limiter release flag in the flash memory 12b to “OFF,” and then the process returns to step 120.

As described above, the main microcomputer 12d rewrites the limiter release flag to “ON” to turn on the speed limit release mode when the predetermined first condition is fulfilled, and rewrites the limiter release flag to “OFF” to turn off the speed limit release mode when the predetermined second condition is fulfilled.

The drive control ECU 13 does not perform the speed limiter control when the speed limit release mode is turned on, to be mentioned later, and the drive control ECU 13 performs the speed limiter control when the speed limit release mode is turned off.

The first condition and the second condition are explained in the following. The first condition needs to be fulfilled as a necessary and sufficient condition to turn the speed limit release mode from off to on. For example, the first condition may be a condition “(a) a position of the vehicle is in a predetermined area, and (b) a user turns on the speed limit release mode by using the operation unit (not illustrated) of the navigation system 12.” As the predetermined area, an area in a motor sport circuit may be specified, for example.

The second condition needs to be fulfilled as a necessary and sufficient condition to turn the speed limit release mode from on to off. For example, the second condition may be a condition “(a) a position of the vehicle is not in the predetermined area, or (b) the user turns of the speed limit release mode by using the operation unit.”

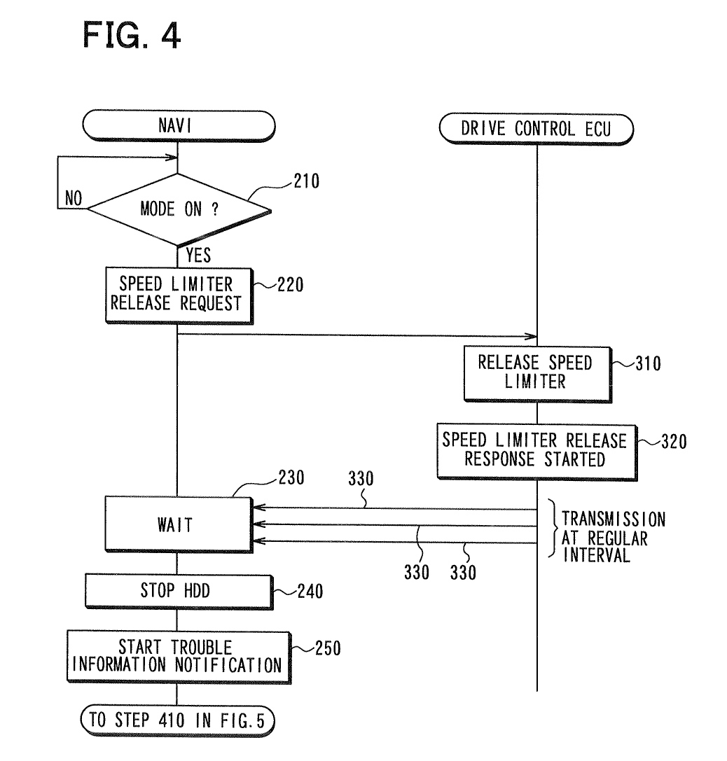

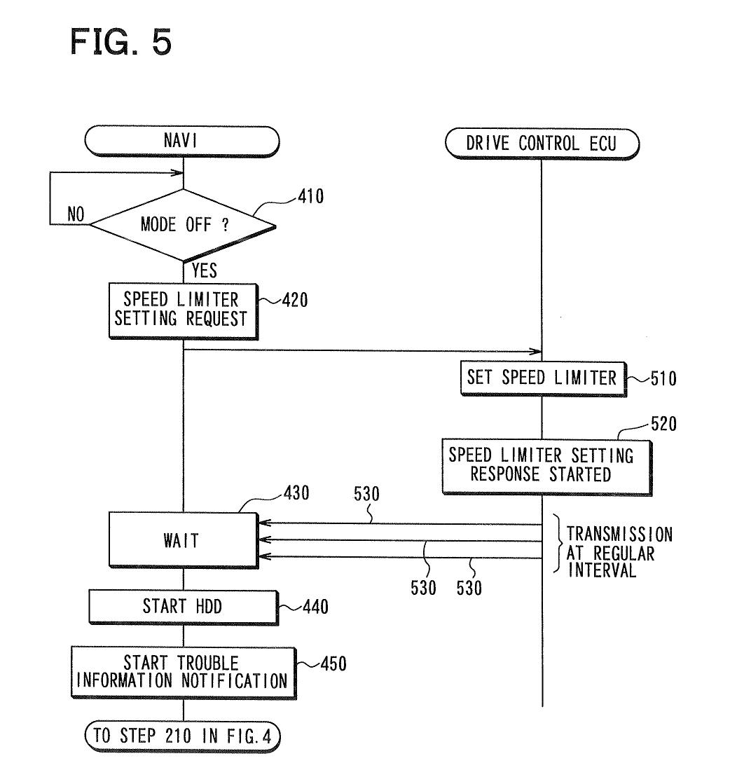

The mode corresponding control process 23 for mode is explained next. The mode corresponding control process 23 is for performing various processes according to the switching on and off of the speed limit release mode. FIGS. 4 and 5 show a flowchart of the mode corresponding control process 23 and a flowchart of operation of the drive control ECU 13 during an execution time of the mode corresponding control process 23.

In the speed limit release mode setting process 22, at a time of start of the navigation system 12, the main microcomputer 12d starts to execute a process from step 210 shown in FIG. 4 if the speed limit release mode is being turned off, or starts to execute a process from step 410 shown in FIG. 5 if the speed limit release mode is being turned on. In addition, determination of whether the speed limit release mode is on or off is performed based on whether the speed limiter release flag in the flash memory 12b is on or off.

In the following, a case that the speed limit release mode is being turned on at the time of start of the navigation system 12 is explained. In this case, at step 210, the process waits for turning on of the speed limit release mode. Then, after turning on of the speed limit release mode by the speed limit release mode setting process 22, the determination result of step 210 indicates YES (=in the affirmative), and a speed limiter release request is transmitted to the drive control ECU 13 at step 220.

The drive control ECU 13 which has received the speed limiter release request finishes the speed limiter control at step 310, as mentioned before. In other words, a speed limiter is released. Thus, the vehicle can increase a travel speed up to the maximum speed of the vehicle's performance, exceeding the first upper limit speed. The vehicle having the speed limiter control finished may be used, for example, in a racing circuit for traveling at a high speed.

When the speed limiter control is finished, the drive control ECU 13 starts to transmit a speed limiter release response signal 330 to the navigation system 12 at regular intervals at step 320.

In addition, the main microcomputer 12d, which has performed the speed limiter release request at step 220, waits for reception of the speed limiter release response signal from the drive control ECU 13 for predetermined times (e.g. for three times) at step 230.

When the speed limiter release response signal is received for predetermined times, a process for stopping the hard disk 12a is executed at step 240. More practically, power supply to the hard disk 12a is stopped. Stopping of the power supply to the hard disk 12a may be performed, for example, by turning off a switch on a power supply line for supplying power from a main battery of the vehicle to the hard disk 12a.

By the above process, power supply to the hard disk 12a stops, and the rotation of the disk of the hard disk 12a stops, and a magnetic head in the hard disk 12a is immobilized. Therefore, possibility of trouble of the hard disk 12a is decreased even if the vehicle performs a high-speed travel, causing a strong vibration and a large lateral acceleration on the hard disk 12a, because the magnetic head in the hard disk 12a is immobilized, thereby not having access to the disk.

At step 250, execution of the trouble information notification process 21 is stopped. In this manner, the trouble occurrence information output to the navigation system 12 from ECUs 13 to 18 is not transmitted to the data collection center 2, and is discarded in the navigation system 12.

After step 250, the process proceeds to step 410 in FIG. 5, and the main microcomputer 12d waits for turning off of the speed limit release mode. When the speed limit release mode is turned from on to off by the speed limit release mode setting process 22, the determination result of step 410 indicates YES (=in the affirmative), and the speed limiter setting request is transmitted to the drive control ECU 13 at step 420.

The drive control ECU 13, which has received the speed limiter setting request starts the speed limiter control at step 510, as mentioned above. In other words, a speed limiter is set in use. The speed limiter does not allow the vehicle to raise the travel speed to the maximum speed of the vehicle's performance, exceeding the first upper limit speed.

When the speed limiter control starts, the drive control ECU 13 starts to transmit the speed limiter setting response signal 530 to the navigation system 12 at regular intervals at step 520.

In addition, the main microcomputer 12d, which has performed a speed limiter setting request at step 420, waits for reception of the speed limiter setting response signal for predetermined times (e.g., for three times) from the drive control ECU 13 at step 430.

When receiving the speed limiter setting response signal for predetermined times, the hard disk 12a is started at step 440. More practically, electric power supply to the hard disk 12a is restarted. In this manner, writing data to and reading data from the hard disk 12a are enabled thereafter.

At step 450, execution of the trouble information notification process 21 is restarted. In this manner, the trouble occurrence information output to the navigation system 12 from ECUs 13 to 18 after the restart of the trouble information notification process 21 is transmitted to the data collection center 2. After step 450, the process proceeds to step 210 of FIG. 4.

As mentioned in the above, the main microcomputer 12d controls the drive control ECU 13 in the vehicle to set an upper limit of an allowable range of vehicle's travel speed to have the first upper limit speed (step 420) if, the speed limit release mode is being turned off, and controls the drive control ECU 13 in the vehicle to release the upper limit of the allowable range of vehicle's travel speed if the speed limit release mode is being turned on (step 220).

Further, the main microcomputer 12d stops the operation of the hard disk 12a when the speed limit release mode is turned on (step 240). Because the operation of the hard disk 12a stops in the above-described manner when the speed limit release mode is turned on, possibility of trouble of the hard disk 12a is decreased.

The main microcomputer 12d stops transmission of the trouble occurrence information to the center 2 when the speed limit release mode is turned on (step 250). Because the transmission of the trouble occurrence information to the center 2 is stopped in the above-described manner when the speed limit release mode is turned on, unnecessary noise information transmitted to the center 2 is reduced.

Furthermore, the main microcomputer 12d rewrites the limiter release flag in the flash memory 12b for switching on and off the speed limit release mode, and determines whether the speed limit release mode is being turned on or off.

In case that, different from the above, turning on and off of the speed limit release mode is performed by rewriting the information in the hard disk 12a, the switching of the speed limit release mode as well as the determination of the speed limit release mode become impossible, due to the inaccessibility to the hard disk 12a during an ON time of the speed limit release mode. The present invention avoids this problem by using the flash memory 12b, instead of the hard disk 12a, for storing the information. A similar problem of use of a random access memory (RAM) can also be avoided when the information is stored in the flash memory. That is, if the information is stored in the RAM for switching on and off of the speed limit release more, the information in the RAM may be unstable due to a frequent rewriting and/or erasure of the information during an engine start period. However, the non-volatile flash memory 12b is not susceptible to the instability of electric supply during the engine start period, thereby resolving the above-described problem.

### Other Embodiments

Although the present disclosure has been fully described in connection with preferred embodiment thereof with reference to the accompanying drawings, it is to be noted that various changes and modifications will become apparent to those skilled in the art.

For example, the main microcomputer 12d may set a flag for hard disk access prohibition in the flash memory 12b turned on at step 240. Further, the main microcomputer 12d may be configured not to perform reading from and writing to the hard disk 12a when the flag for hard disk access prohibition is turned on during an execution time of any program.

In addition, the main microcomputer 12d may set the flag for hard disk access prohibition in the flash memory 12b turned off at step 440. Further, the main microcomputer 12d may be configured to perform reading from and writing to the hard disk 12a as required when the flag for hard disk access prohibition is turned off during an execution time of any program.

Furthermore, each function realized by the main microcomputer 12d through execution of a program may be realized by using hardware such as FPGA which, for example, can be programmed to serve as a required circuit.

Such changes, modifications, and summarized scheme are to be understood as being within the scope of the present disclosure as defined by appended claims.

What is claimed is:

1. A trouble notification apparatus for use in a vehicle for transmitting trouble occurrence information regarding a trouble of the vehicle to an information center outside of the vehicle, the apparatus comprising:
an information transmitting unit for transmitting the trouble occurrence information to the information center;
a speed limit release mode setting unit for setting ON and OFF of a speed limit release mode, wherein the speed limit release mode is turned ON when a first condition is fulfilled and the speed limit release mode is turned OFF when a second condition is fulfilled;
an upper speed limit control unit for controlling a travel speed of the vehicle, wherein, based on a control of a drive control unit in the vehicle, the travel speed of the vehicle is set to be within a speed range having a first upper limit speed during an OFF period of the speed limit release mode, and, the travel speed of the vehicle is allowed to exceed the first upper limit speed during an ON period of the speed limit release mode; and
a notification stopping unit for stopping transmission of the trouble occurrence information to the information collection center by the information transmitting unit during the ON period of the speed limit release mode.

2. An in-vehicle apparatus for use in a vehicle, the apparatus comprising:
a hard disk;
a speed limit release mode setting unit for turning on and off of a speed limit release mode, wherein the speed limit release mode is turned on when a first condition is fulfilled, and the speed limit release mode is turned off when a second condition is fulfilled;
an upper speed limit control unit for controlling a travel speed of the vehicle, wherein, based on a control of a drive control unit in the vehicle, the travel speed of the vehicle is set to be within a speed range having a first upper limit speed in the vehicle during an ON period of the speed limit release mode, and, the travel speed of the vehicle is allowed to exceed the first upper limit speed during an OFF period of the speed limit release mode; and
a hard disk control unit for controlling an operation of the hard disk, wherein the operation of the hard disk is stopped during an ON period of the speed limit release mode.

3. The in-vehicle apparatus in claim 2 further comprising a flash memory, wherein
the speed limit release mode setting unit switches ON and OFF of the speed limit release mode by rewriting information stored in the flash memory, and
the upper speed limit control unit and the hard disk control unit determine whether the speed limit release mode is being turned ON or OFF based on the information stored in the flash memory.
